(19) United States
(12) Patent Application Publication
(10) Pub. No.: US 2025/0346080 A1
(43) Pub. Date: Nov. 13, 2025

(54) BRACKET

(71) Applicant: Yamaguchi Wrecker Co., Ltd., Kanagawa (JP)

(72) Inventor: Kazuki WAKANO, Kanagawa (JP)

(21) Appl. No.: 19/201,264

(22) Filed: May 7, 2025

(30) Foreign Application Priority Data
May 8, 2024 (JP) 2024-076136
Apr. 17, 2025 (JP) 2025-068055

(51) Int. Cl. B60D 1/52; B60P 3/06

(52) U.S. Cl. CPC B60D 1/52; B60P 3/06

(57) ABSTRACT

A bracket to load, secure, and unload a cart efficiently, includes a cart support unit configured to support a wheel support member using a support plate open on upper and front; a door plate unit configured to secure the outer periphery of the wheel support member supported on the support plate; a rotation support unit configured to support the door plate unit rotatably; and a lock unit configured to restrict rotation of the door plate unit when the door plate unit is closed to the support plate and permit rotation when the restriction is released.

This application is based on and claims the benefit of priority from Japanese Patent Application Nos. 2024-076136 and 2025-068055, respectively filed on 8 May 2024 and 17 Apr. 2025, the contents of which are incorporated herein by reference.

### BACKGROUND OF THE INVENTION

### Field of the Invention

The present invention relates to a bracket.

### Related Art

Traditionally, for towing and thus transporting a vehicle with a tow truck, a vehicle transport cart referred to as a dolly is used to support either the rear wheels or the front wheels of the vehicle (see, for example, Japanese Unexamined Patent Application, Publication No. 2014-76709 and Japanese Unexamined Patent Application, Publication No. 2024-94647).

Patent Document 1: Japanese Unexamined Patent Application, Publication No. 2014-76709

Patent Document 2: Japanese Unexamined Patent Application, Publication No. 2024-94647

### SUMMARY OF THE INVENTION

Typical small tow trucks have brackets installed on the beds thereof for carrying vehicle transport carts. A conventional bracket has a U-shaped part with an open top for carrying a vehicle transport cart. When loading or unloading the vehicle transport cart, therefore, an operator needs to perform the task while lifting the vehicle transport cart higher than the opening of the bracket. Furthermore, in the case of the conventional bracket, there is a risk that the vehicle transport cart can come off the bracket due to vibration or the like during transport. The operator therefore needs to secure the vehicle transport cart and the bracket together using a chain lock or the like, which involves the action of locking and unlocking. An object of the present invention is to provide a bracket that makes it possible to load, secure, and unload a vehicle transport cart efficiently.

An aspect of the present invention is directed to a bracket for securing a vehicle transport cart having wheels respectively provided on opposite sides of a wheel support member in a longitudinal direction. The bracket includes: a cart support unit configured to support the wheel support member using a support plate that is open on upper and front sides; a door plate unit configured to secure an outer periphery of the wheel support member supported on the support plate; a rotation support unit configured to support the door plate unit in a rotatable manner; and a lock unit configured to restrict rotation of the door plate unit when the door plate unit is closed with respect to the support plate and permit the rotation of the door plate unit when the restriction is released. The rotation of the door plate unit is restricted by the lock unit as a result of the door plate unit being closed with respect to the support plate after the vehicle transport cart has been loaded from the front side of the support plate and supported on the support plate. The vehicle transport cart is allowed to be taken out from the front side as a result of the door plate unit being opened with respect to the support plate after the restriction has been released and the rotation of the door plate unit has been permitted.

According to the present invention, it is possible to provide a bracket that makes it possible to load, secure, and unload a vehicle transport cart efficiently.

### BRIEF DESCRIPTION OF THE DRAWINGS

FIG. 1 is a conceptual diagram showing a tow truck with a bracket according to an embodiment installed thereon and a vehicle transport cart secured to the bracket;

FIG. 2 is a perspective view of the bracket with a door plate unit closed, as viewed obliquely from the front;

FIG. 3 is a perspective view of the bracket with the door plate unit open, as viewed obliquely from the front;

FIG. 4 is a perspective view of the bracket with the door plate unit closed, as viewed obliquely from the back;

FIG. 5 is a front view of the bracket;

FIG. 6 is a cross-sectional view taken along line s1-s1 in FIG. 5;

FIG. 7 is a back view of the bracket and a partially enlarged view thereof;

FIG. 8 is a perspective view of the vehicle transport cart placed on the bracket; and

FIG. 9 is a perspective view of the vehicle transport cart secured to the bracket.

### DETAILED DESCRIPTION OF THE INVENTION

The following describes a bracket according to an embodiment of the present invention. It should be noted that the drawings attached to the present specification are all schematic diagrams. For ease of understanding, for example, the shapes, scale, height-to-width aspect ratios, and the like of components in the drawings may differ from or be exaggerated relative to actual components. Furthermore, in the drawings, hatching that indicates cross sections of members is omitted as appropriate.

In the present specification and the like, terms used to specify shapes, geometrical conditions, and degrees thereof, such as “perpendicular” or “direction”, are intended to encompass not only strict meanings thereof but also ranges that can be regarded as substantially perpendicular or approximately in the specified direction.

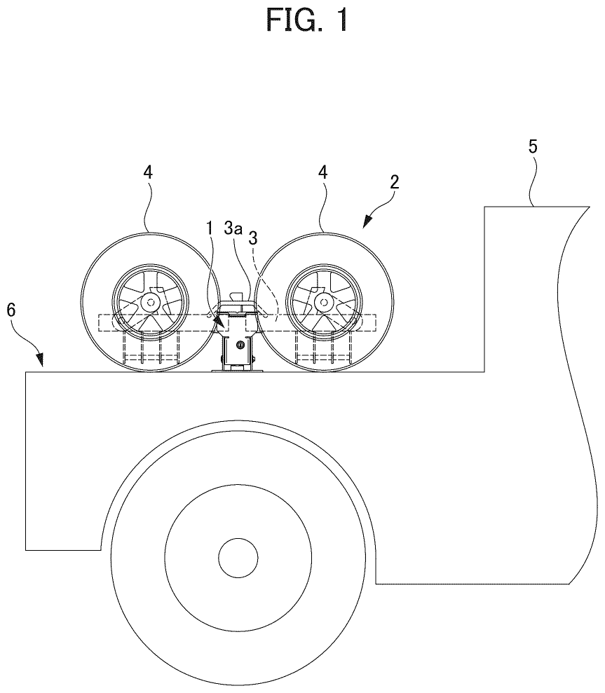

In the present specification and the like, as shown in FIG. 1, the left-right direction, the front-back direction, and the up-down direction are referred to as X (X1-X2) direction, Y (Y1-Y2) direction, and Z (Z1-Z2) direction, respectively, based on a front view of a bracket 1 installed on a bed 6 of a tow truck 5. It should be noted that “ . . . direction” may be referred to as “ . . . side” as appropriate in the present specification.

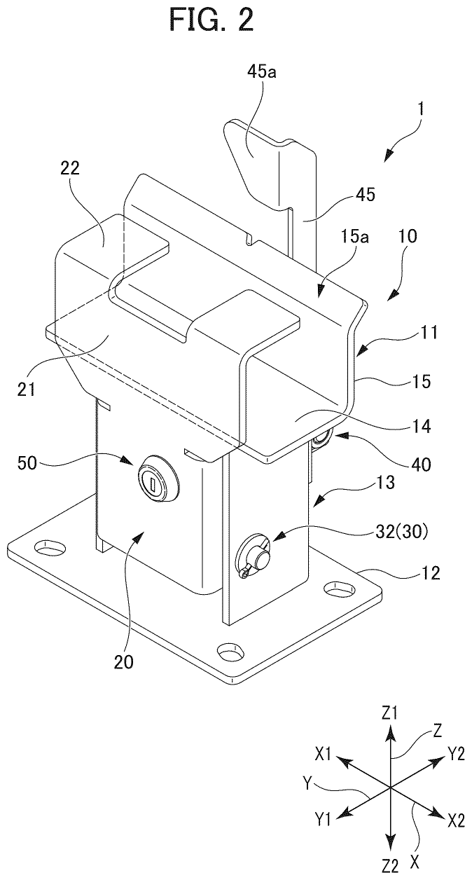

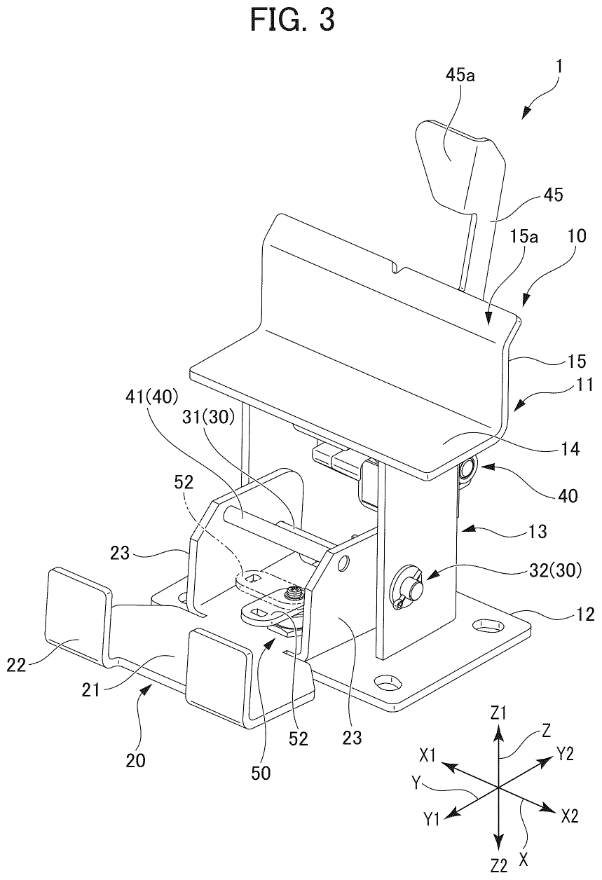

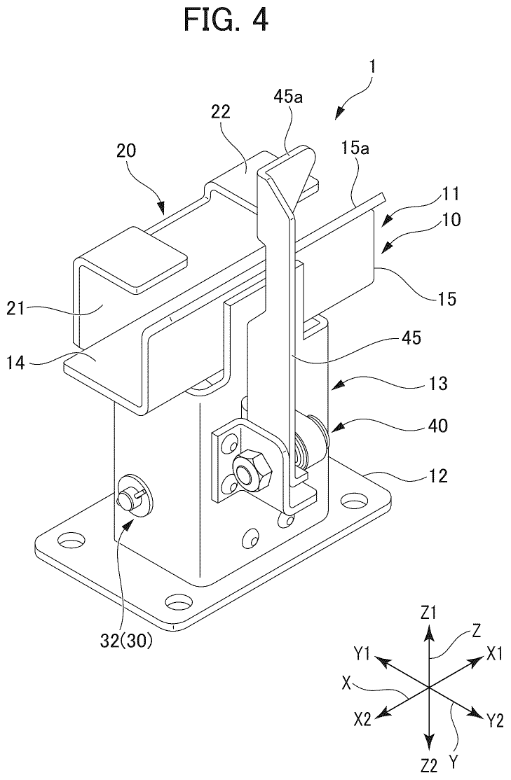

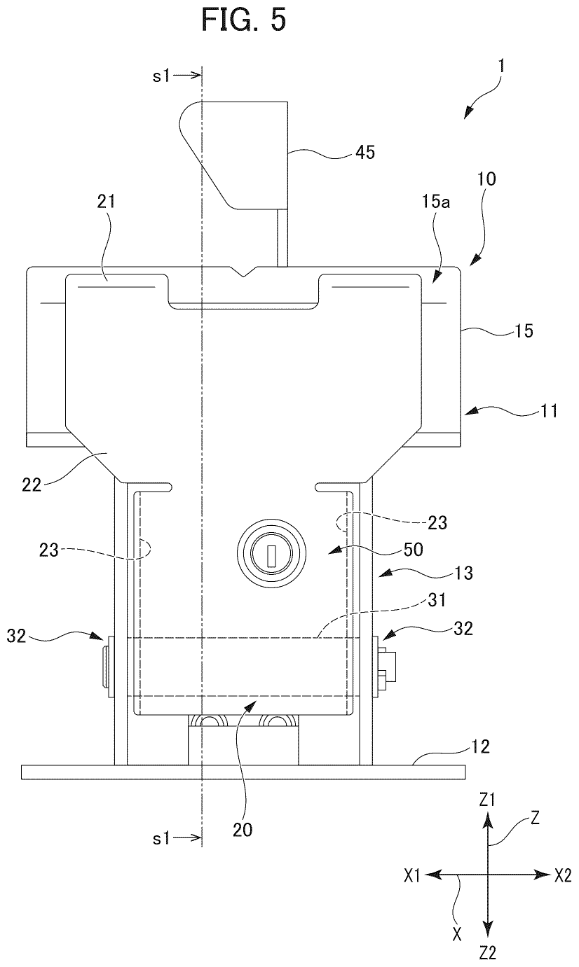

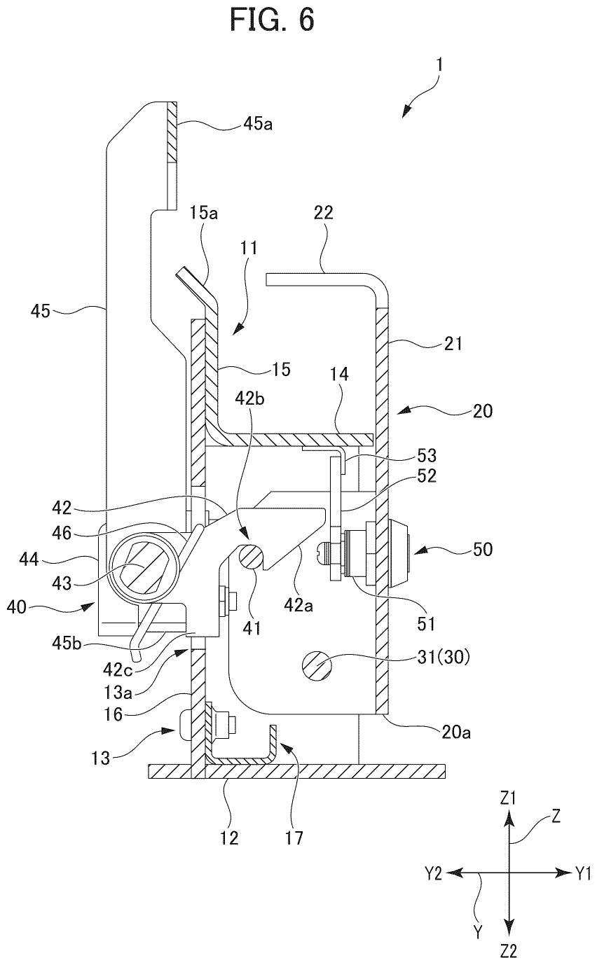

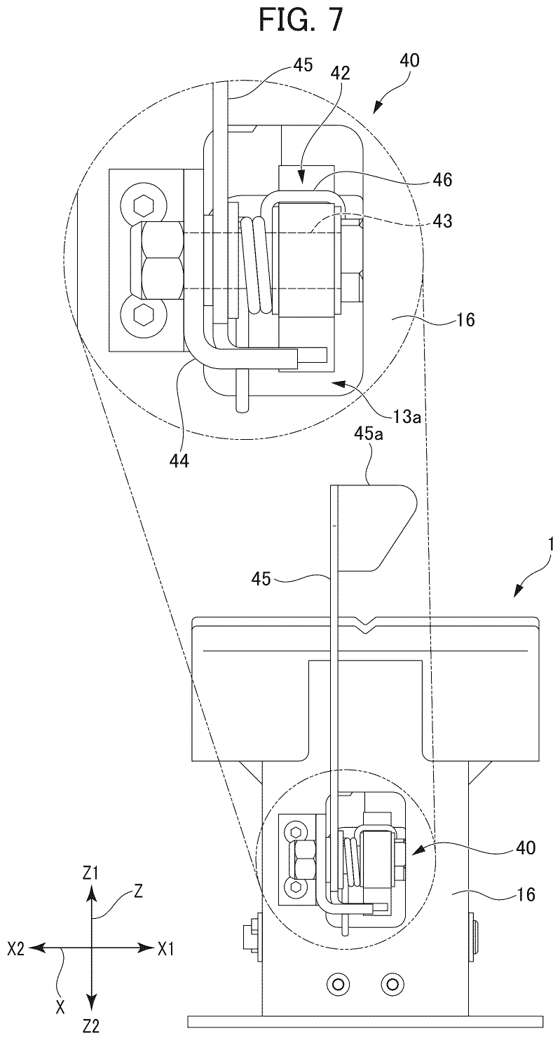

FIG. 1 is a conceptual diagram showing a tow truck with a bracket according to an embodiment installed thereon and a vehicle transport cart secured to the bracket. FIG. 2 is a perspective view of the bracket with a door plate unit closed, as viewed obliquely from the front (front side Y1). FIG. 3 is a perspective view of the bracket with the door plate unit open, as viewed obliquely from the front. FIG. 4 is a perspective view of the bracket with the door plate unit closed, as viewed obliquely from the back (back side Y2). FIG. 5 is a front view of the bracket. FIG. 6 is a cross-sectional view taken along line s1-s1 in FIG. 5. FIG. 7 is a back view of the bracket and a partially enlarged view thereof.

As shown in FIG. 1, a vehicle transport cart 2 is secured to the bracket 1 (described below) installed on the bed 6 of the tow truck 5. The vehicle transport cart 2 includes a wheel support member 3, a pair of wheels 4, and other components. The wheel support member 3 of the present embodiment is composed of a quadrangular prism-shaped member, and the wheels 4 are respectively provided on opposite ends of the wheel support member 3 in the longitudinal direction in a rotatable manner. The wheel support member 3 has a frame part 3a provided approximately at the center thereof in the longitudinal direction. The frame part 3a is a member that restricts the vehicle transport cart 2 secured to the bracket 1 from moving in the left-right direction. Although FIG. 1 shows only the bracket 1 installed on the near side of the bed 6, another bracket 1 (not shown) having the same configuration is installed on the opposite side of the bed 6, and a vehicle transport cart 2 having the same configuration as the vehicle transport cart 2 on the near side is secured thereto. At a work site, a plurality of crossbars (not shown) are laid between the pair of vehicle transport carts 2 unloaded from the tow truck 5, and wheels of a vehicle to be towed are placed thereon.

As shown in FIGS. 2 to 4, each bracket 1 includes, for example, a cart support unit 10, a door plate unit 20, a rotation support unit 30, a lock unit 40, and a key lock unit 50. These components of the bracket 1, with some exceptions, are made of steel, for example.

The cart support unit 10 includes a support plate 11, a substrate 12, and a support frame 13. The support plate 11 is a member for supporting the wheel support member 3. As shown in FIG. 6, the support plate 11 includes a bottom plate part 14 and a back plate part 15 arranged perpendicular to each other in a cross-sectional view. The bottom plate part 14 is a member located on the lower side Z2 of the support plate 11. The back plate part 15 is a member located on the back side Y2 of the support plate 11. The support plate 11 is open on the upper side Z1 and the front side Y1. The upper side Z1 of the back plate part 15 has an inclined portion 15a. The inclined portion 15a is a portion of the back plate part 15 that is inclined in the back direction Y2.

The substrate 12 is a member that is secured to the bed 6 of the tow truck 5 (see FIG. 1). The substrate 12 is, for example, secured to the bed 6 with fasteners such as bolts.

The support frame 13 is a member provided between the support plate 11 and the substrate 12. The support frame 13 is generally U-shaped in a plan view from the Z1 direction. An end of the upper side Z1 of the support frame 13 is joined to the support plate 11 (bottom plate part 14). An end of the lower side Z2 of the support frame 13 is joined to the substrate 12. As shown in FIG. 4 or the like, the lock unit 40 (described below) is provided on the back side Y2 of the support frame 13. As shown in FIG. 7, a frame plate 16, which is provided on the back side Y2 of the support frame 13, has an opening 13a that allows a portion of a lock lever 42 to protrude in the front direction Y1.

As shown in FIG. 6, a stopper 17 is provided on the inner side of the frame plate 16 and at an end of the lower side Z2 of the frame plate 16. The stopper 17 is a component that comes into contact with an end 20a of the lower side Z2 of the door plate unit 20 to restrict the rotation of the door plate unit 20 when the door plate unit 20 is opened with respect to the support plate 11. With the stopper 17 provided on the support frame 13, as shown in FIG. 3, it is possible to support the door plate unit 20 opened with respect to the support plate 11 at a position where the door plate unit 20 is kept from making contact with a surface on which the bracket 1 is installed (surface to which the substrate 12 is secured). Thus, it is possible to reduce the risk of the key lock unit 50 colliding with the surface on which the bracket 1 is installed when the door plate unit 20 is opened with respect to the support plate 11, and resulting in damage or operational failure.

The door plate unit 20 is a member that secures the outer periphery of the wheel support member 3 supported on the support plate 11 (cart support unit 10) together with the support plate 11. As shown in FIG. 2, the door plate unit 20 includes a front plate part 21 and a top plate part 22 as parts that are opposed to the support plate 11. The front plate part 21 is a member that is positioned on the front side Y1 when the door plate unit 20 is closed. The top plate part 22 is a member that is positioned on the upper side Z1 when the door plate unit 20 is closed. In the present embodiment, an outer width of the top plate part 22 in the left-right direction X is set to be smaller than an inner width of the frame part 3a (see FIG. 1) in the left-right direction X.

As shown in FIG. 6, the bottom plate part 14 and the back plate part 15 of the support plate 11, and the front plate part 21 and the top plate part 22 of the door plate unit 20 are positioned so as to enclose the outer periphery of the wheel support member 3 when the door plate unit 20 is closed with respect to the support plate 11. This configuration allows the outer periphery of the wheel support member 3 supported on the support plate 11 to be enclosed and thus secured by the four plate members (the bottom plate part 14, the back plate part 15, the front plate part 21, and the top plate part 22) when the door plate unit 20 is closed with respect to the support plate 11.

As shown in FIG. 3, the door plate unit 20 has a generally U-shaped part that is fitted into the support frame 13 (cart support unit 10). That is, the door plate unit 20 has a configuration in which opposite end portions thereof in the left-right direction X are bent at a right angle, respectively forming side plate parts 23. The rotation support unit 30, an engagement shaft 41 of the lock unit 40, and the key lock unit 50 are provided on the door plate unit 20.

The rotation support unit 30 is a mechanism that supports the door plate unit 20 in such a manner as to allow the door plate unit 20 to rotate with respect to the support frame 13. As shown in FIG. 3, the rotation support unit 30 includes a rotation support shaft 31 and retainers 32. The rotation support shaft 31 is a rod-shaped member that supports the rotation of the door plate unit 20. As shown in FIG. 5, the rotation support shaft 31 is provided so as to penetrate side faces of the support frame 13 in the left-right direction X, and the left and right side plate parts 23 of the door plate unit 20. Opposite ends of the rotation support shaft 31 in the longitudinal direction are secured using the retainers 32. The retainers 32 are provided on the side faces of the support frame 13 in the left-right direction X.

The configuration described above enables the door plate unit 20 to rotate around the rotation support shaft 31. Rotating the door plate unit 20 around the rotation support shaft 31 in such a manner as to raise the door plate unit 20 closes the door plate unit 20 with respect to the support plate 11 (see FIG. 2). Rotating the door plate unit 20 around the rotation support shaft 31 in such a manner as to lower the door plate unit 20 opens the door plate unit 20 with respect to the support plate 11 (see FIG. 3).

As shown in FIG. 3, the engagement shaft 41 is provided inside the door plate unit 20. The engagement shaft 41 is a rod-shaped member that engages with the lock lever 42 (described below). The engagement shaft 41 is laid between the pair of left and right side plate parts 23 of the door plate unit 20.

The key lock unit 50 is a mechanism that is switchable between a locked position for restricting the rotation of the door plate unit 20 closed with respect to the support plate 11 and an unlocked position for permitting the rotation of the door plate unit 20. The key lock unit 50 of the present embodiment is configured as a cam lock. As shown in FIG. 6, the key lock unit 50 includes a cylinder 51, a cam 52, and a cam hook 53.

The cylinder 51 is a mechanism that causes the cam 52 to rotate to a locked position or an unlocked position as the operator turns a key (not shown) inserted therein. The cam 52 is a plate-like member connected to the cylinder 51. The cam 52 rotates to the locked position or the unlocked position as the operator turns the key inserted into the cylinder 51 in a locking direction or an unlocking direction. FIG. 6 shows the cam 52 that has rotated to the locked position using a solid line, and the cam 52 that has rotated to the unlocked position using a phantom line (dashed and double dotted line).

The cam hook 53 is a member that engages with the cam 52 that has rotated to the locked position. As shown in FIG. 6, the cam hook 53 is provided on the lower side (underside) Z2 of the support plate 11. When the operator inserts the key into the cylinder 51 and turns the key in the locking direction, the cam 52 engages with the cam hook 53 in the locked position as shown in FIG. 6. As a result, a locked state is achieved in which the rotation of the door plate unit 20 with respect to the support plate 11 is restricted. By contrast, in the locked state, the operator inserts the key into the cylinder 51 of the key and turns the key in the unlocking direction. As a result, in the unlocked position, the cam 52 disengages from the cam hook 53. As a result, an unlocked state is achieved in which the rotation of the door plate unit 20 is permitted.

The following describes a configuration of the lock unit 40. The lock unit 40 is a mechanism that restricts the rotation of the door plate unit 20 when the door plate unit 20 is closed with respect to the support plate 11, and permits the rotation of the door plate unit 20 when this restriction is released. As shown in FIGS. 6 and 7, the lock unit 40 includes, for example, the engagement shaft (rod-shaped member) 41, the lock lever (hook-shaped part) 42, a secured shaft 43, a lock lever bracket 44, an operation lever 45, and a coil spring (biasing part) 46.

The lock lever 42 is a component that engages with the engagement shaft 41. The lock lever 42 is supported in such a manner as to be rotatable with respect to the secured shaft 43 (described below). As shown in FIG. 6, the lock lever 42 includes a slide portion 42a, a recess portion 42b, and a projection portion 42c. The slide portion 42a guides the engagement shaft 41 in the door plate unit 20 to the position of the recess portion 42b when the door plate unit 20 is closed with respect to the support plate 11. The recess portion 42b engages with the engagement shaft 41 when the door plate unit 20 is closed with respect to the support plate 11. The slide portion 42a and the recess portion 42b are configured to protrude from the opening 13a of the support frame 13 in the front direction Y1. The projection portion 42c comes into contact with a pressing portion 45b (described below) of the operation lever 45.

The secured shaft 43 is a member that supports the lock lever 42 in a rotatable manner. As shown in the partially enlarged view in FIG. 7, the secured shaft 43 is secured to the lock lever bracket 44 via a nut, a washer, and the like (reference numerals omitted). The lock lever bracket 44 is a member that supports the lock lever 42, the secured shaft 43, the operation lever 45, the coil spring 46, and the like. As shown in FIG. 6, the lock lever bracket 44 is provided on a surface of the back side Y2 of the support frame 13 (cart support unit 10).

The operation lever 45 is a member that causes the lock lever 42 to rotate in a direction for disengaging the lock lever 42 from the engagement shaft 41. The operation lever 45 is supported on the secured shaft 43 in a rotatable manner. An operation portion 45a is provided at an end of the upper side Z1 of the operation lever 45. The operation portion 45a is pushed by the operator for disengaging the lock lever 42 from the engagement shaft 41. In the following description, the operator's operation of pushing the operation lever 45 for disengaging the lock lever 42 from the engagement shaft 41 is also referred to as a “disengaging operation”. As shown in FIG. 2 and the like, the operation portion 45a protrudes from the bracket 1 toward the upper side Z1. This configuration makes it easy for the operator to see the position of the operation lever 45 and enhances operability.

As shown in FIG. 6, the pressing portion 45b is provided at an end of the lower side Z2 of the operation lever 45. The pressing portion 45b causes the projection portion 42c of the lock lever 42 to rotate in a disengaging direction against biasing force of the coil spring 46 when the disengaging operation is performed on the operation lever 45. In the cross-sectional view in FIG. 6, the disengaging direction of the lock lever 42 is a counterclockwise direction around the secured shaft 43. It should be noted that upon the operator taking his/her hand off the operation lever 45 after the lock lever 42 has disengaged from the engagement shaft 41, the operation lever 45 returns to its original position due to the biasing force of the coil spring 46 (described below) transmitted from the projection portion 42c of the lock lever 42 via the pressing portion 45b (see FIG. 6).

The coil spring 46 is an elastic member that biases the lock lever 42 in a direction for engaging the lock lever 42 with the engagement shaft 41 around the secured shaft 43. In the cross-sectional view in FIG. 6, the direction for engaging the lock lever 42 with the engagement shaft 41 is a clockwise direction around the secured shaft 43. The coil spring 46 is mounted coaxially with the secured shaft 43. As shown in FIG. 6, one end of the coil spring 46 is in contact with the lock lever bracket 44. An opposite end of the coil spring 46 is in contact with the lock lever 42.

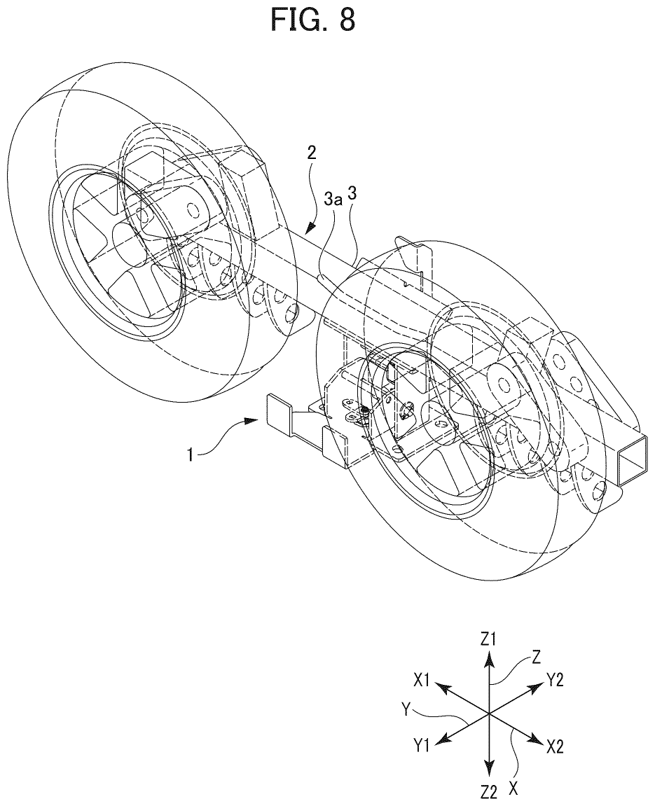

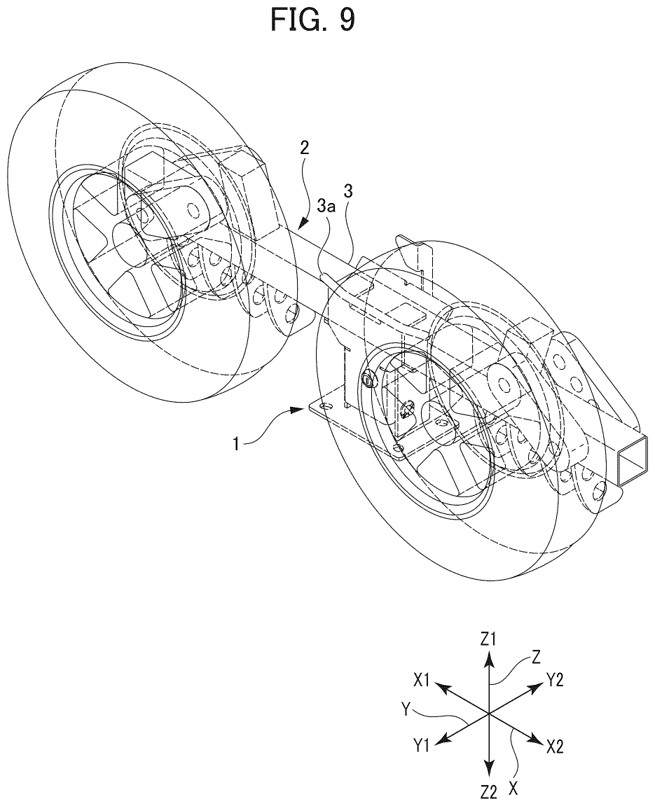

The following describes an operation of loading and unloading the vehicle transport cart 2 in relation to the bracket 1 having the above-described configuration. FIG. 8 is a perspective view of the vehicle transport cart placed on the bracket. FIG. 9 is a perspective view of the vehicle transport cart secured to the bracket.

As shown in FIG. 2, when placing the vehicle transport cart 2 on the bracket 1 with the door plate unit 20 closed, the operator pushes the operation portion 45a of the operation lever 45 in the back direction Y2. As the operator pushes the operation portion 45a of the operation lever 45 in the back direction Y2, the pressing portion 45b of the operation lever 45 presses the projection portion 42c (see FIG. 6) of the lock lever 42 in the disengaging direction around the secured shaft 43. In the cross-sectional view in FIG. 6, the direction for disengaging the lock lever 42 using the pressure exerted by the pressing portion 45b is a counterclockwise direction around the secured shaft 43.

Once the lock lever 42 has rotated in the disengaging direction and disengaged from the engagement shaft 41, the operator can open the door plate unit 20 around the rotation support shaft 31. It should be noted that the door plate unit 20 has components located above the rotation support shaft 31 in the upper side Z1, such as the front plate part 21, the top plate part 22, and the key lock unit 50. Therefore, once the lock lever 42 has disengaged from the engagement shaft 41, the door plate unit 20 automatically opens by rotating around the rotation support shaft 31 due to the weight of the components located above the rotation support shaft 31 in the upper side Z1 (weight of the door plate unit 20 itself) as shown in FIG. 3.

With the door plate unit 20 open with respect to the support plate 11, the operator can place the vehicle transport cart 2 on the bracket 1 as shown in FIG. 8. A middle portion of the wheel support member 3 of the vehicle transport cart 2 in the longitudinal direction is placed on the support plate 11 of the bracket 1.

As the operator closes the door plate unit 20 with respect to the support plate 11 of the bracket 1 having the vehicle transport cart 2 placed on the support plate 11, the engagement shaft 41 moves toward the recess portion 42b while sliding on an inclined surface of the slide portion 42a. Specifically, in FIG. 6, the engagement shaft 41 moves toward the recess portion 42b through relative sliding on the inclined surface of the slide portion 42a. This movement causes the lock lever 42 to rotate against the biasing force of the coil spring 46 (rotate counterclockwise in FIG. 6). Once the engagement shaft 41 has passed the slide portion 42a and reached the position of the recess portion 42b, the engagement shaft 41 engages with the recess portion 42b. As a result of the engagement shaft 41 engaging with the recess portion 42b, the rotation of the door plate unit 20 is restricted. Thus, the vehicle transport cart 2 can be held and secured between the support plate 11 and the door plate unit 20 of the bracket 1 as shown in FIG. 9. Furthermore, as the operator closes the door plate unit 20 with respect to the support plate 11, the top plate part 22 of the door plate unit 20 is fitted into the frame part 3a of the vehicle transport cart 2. Thus, the vehicle transport cart 2 secured to the bracket 1 can be restricted from moving in the left-right direction X due to vibration or the like.

On the other hand, when removing the vehicle transport cart 2 secured to the bracket 1 from the bracket 1, the operator pushes the operation portion 45a of the operation lever 45 in the back direction Y2. As a result, as described above, the door plate unit 20 opens with respect to the support plate 11, opening the upper side Z1 and the front side Y1 of the support plate 11, so that the operator can remove the vehicle transport cart 2 from the front side Y1 of the bracket 1.

The bracket 1 according to the present embodiment described above produces, for example, the following effects. When placing the vehicle transport cart 2 on the bracket 1 according to the present embodiment, the operator opens the door plate unit 20. In the bracket 1 in this state, the upper side Z1 and the front side Y1 of the support plate 11 are open. This configuration allows the operator to place the vehicle transport cart 2 on the bracket 1 from the front side Y1 of the support plate 11 by lifting the vehicle transport cart 2 to the height of the bottom plate part 14, without the need to lift the vehicle transport cart 2 higher than the top of the bracket 1 toward the upper side Z1.

After placing the vehicle transport cart 2 on the support plate 11 of the bracket 1, the door plate unit 20 is closed with respect to the support plate 11. As a result, the rotation of the door plate unit 20 is restricted. This configuration allows the vehicle transport cart 2 to be secured between the support plate 11 and the door plate unit 20 without the need to secure the bracket 1 and the vehicle transport cart 2 together using a chain lock or the like. Thus, it is possible to prevent problems such as the vehicle transport cart 2 coming off the bracket 1 due to vibration or the like during transport.

On the other hand, when removing the vehicle transport cart 2 from the bracket 1, the operator performs the disengaging operation on the operation lever 45 to release the restriction on the rotation of the door plate unit 20. As a result, the rotation of the door plate unit 20 is permitted, allowing the operator to open the door plate unit 20 with respect to the support plate 11. The operator can remove the vehicle transport cart 2 from the bracket 1 by opening the door plate unit 20 with respect to the support plate 11. In the bracket 1, for removing the vehicle transport cart 2 from the bracket 1, the upper side Z1 and the front side Y1 of the support plate 11 are open. This configuration allows the operator to remove the vehicle transport cart 2 from the bracket 1 at the height of the bottom plate part 14 from the front side Y1, without the need to lift the vehicle transport cart 2 higher than the top of the bracket 1 toward the upper side. This configuration also eliminates the need for the operator to unlock a chain lock or the like for removing the vehicle transport cart 2 from the bracket 1. Thus, the bracket 1 according to the present embodiment makes it possible to load, secure, and unload the vehicle transport cart 2 efficiently.

In the bracket 1 according to the present embodiment, the bottom plate part 14 and the back plate part 15 of the support plate 11, and the front plate part 21 and the top plate part 22 of the door plate unit 20 are positioned so as to enclose the outer periphery of the wheel support member 3 when the door plate unit 20 is closed with respect to the support plate 11. This configuration allows the wheel support member 3 held between the support plate 11 and the door plate unit 20 to be secured in a more stable manner.

The bracket 1 according to the present embodiment includes the lock unit 40 (see FIGS. 6 and 7). After placing the vehicle transport cart 2 on the bracket 1, the door plate unit 20 is closed with respect to the support plate 11. As a result, the lock lever 42 engages with the engagement shaft 41, and the rotation of the door plate unit 20 is restricted. Thus, the vehicle transport cart 2 can be secured between the support plate 11 and the door plate unit 20. In the bracket 1 having the vehicle transport cart 2 secured between the support plate 11 and the door plate unit 20, the engagement between the lock lever 42 and the engagement shaft 41 is maintained by the biasing force of the coil spring 46. As long as the biasing force of the coil spring 46 is set appropriately, therefore, the door plate unit 20 is prevented from opening with respect to the support plate 11 due to vibration or the like, unless the operator performs the disengaging operation on the operation lever 45.

When taking out the vehicle transport cart 2 from the bracket 1, the operator performs the disengaging operation on the operation lever 45 to disengage the lock lever 42 from the engagement shaft 41. As a result, the rotation of the door plate unit 20 is permitted. This state allows the door plate unit 20 to be opened with respect to the support plate 11, and thus allows the operator to remove the vehicle transport cart 2 from the bracket 1. As described above, since the bracket 1 according to the present embodiment includes the lock unit 40, the operator can easily and reliably place and remove the vehicle transport cart 2 on and from the bracket 1.

The bracket 1 according to the present embodiment includes the key lock unit 50 (see FIG. 3). It is therefore possible to restrict the rotation of the door plate unit 20 by locking the key lock unit 50 after securing the bracket 1 to the vehicle transport cart 2. As a result, in the bracket 1 having the vehicle transport cart 2 secured thereto, the lock lever 42 is prevented from disengaging from the engagement shaft 41 even if stress acts on the operation lever 45 due to vibration, shock, or the like. Thus, it is possible to prevent problems such as the vehicle transport cart 2 coming off the bracket 1 as a result of unintended movement of the operation lever 45 due to vibration, shock, or the like.

Furthermore, locking the key lock unit 50 helps prevent theft of the vehicle transport cart 2 loaded onto the tow truck. After securing the vehicle transport cart 2 to the bracket 1 and locking the key lock unit 50, the operator can unlock the key lock unit 50, so that the rotation of the door plate unit 20 is permitted. Thus, the operator can remove the vehicle transport cart 2 supported on the support plate 11 from the bracket 1. As described above, with the key lock unit 50, the bracket 1 according to the present embodiment can keep the secured vehicle transport cart 2 in place more securely.

In the bracket 1 according to the present embodiment, the upper side Z1 of the back plate part 15 of the support plate 11 includes the inclined portion 15a (see FIG. 2). This configuration helps guide the wheel support member 3 colliding with the inclined portion 15a toward the bottom plate part 14 of the support plate 11 even if the operator is placing the vehicle transport cart 2 on the support plate 11 of the bracket 1 from an oblique direction. This configuration also helps prevent the wheel support member 3 from being caught between an edge of the upper side Z1 of the back plate part 15 and the operation lever 45 when the operator is placing the vehicle transport cart 2 on the bracket 1.

Although the bracket according to an embodiment of the present invention has been described above, the present invention is not limited to the embodiment described above. Various modifications and changes such as described below can be made, and the technical scope of the present invention encompasses such modifications and changes. Furthermore, the effects of the embodiment described above are just some of the effects that are produced by the present invention to mention the most preferable effects. The effects of the present invention are not limited to those described above. Although the embodiment described above and modifications described below can be combined as appropriate for use, detailed description thereof will be omitted.

### Modifications

The bracket 1 according to the foregoing embodiment has been described using an example in which the bottom plate part 14 and the back plate part 15 of the support plate 11 are integrally formed. However, the present invention is not limited as such. The support plate 11 may have a configuration in which the bottom plate part 14 and the back plate part 15 formed as separate plates are welded or otherwise joined together, or a configuration in which the bottom plate part 14 and the back plate part 15 formed as separate plates are coupled via fastening members such as bolts and nuts. The same is true for the front plate part 21 and the top plate part 22 of the door plate unit 20.

The bracket 1 according to the foregoing embodiment may have a configuration that does not include the inclined portion 15a, or a configuration that includes a cushioning material or the like instead of the inclined portion 15a. The bracket 1 according to the foregoing embodiment has been described using an example in which the door plate unit 20 is provided with the key lock unit 50. However, the present invention is not limited as such. The bracket 1 may have a configuration that does not include the key lock unit 50, or a configuration that includes, for example, a hook or a ring to which a chain lock or the like is attached instead of the key lock unit 50.

The foregoing embodiment has been described using an example in which the wheel support member 3 (vehicle transport cart 2) has a quadrangular prism shape. However, the present invention is not limited as such. The wheel support member 3 may have, for example, a circular cylindrical shape. In this case, the bracket 1 may have a configuration in which the surfaces of the bottom plate part 14 and the back plate part 15 of the support plate 11, and the front plate part 21 and the top plate part 22 of the door plate unit 20 each have an arc-shaped depression. As described above, in the bracket 1 according to the present embodiment, the shapes of the bottom plate part 14, the back plate part 15, the front plate part 21, and the top plate part 22, which are positioned so as to enclose the wheel support member 3, may be changed as appropriate depending on the shape of the wheel support member 3.

To summarize the description given above, the bracket to which the present invention is applied may take various embodiments as long as the bracket has the following configuration.

(1) A bracket to which the present invention is applied (for example, the bracket 1 shown in FIG. 1) is a bracket for securing a vehicle transport cart having wheels respectively provided on opposite sides of a wheel support member in a longitudinal direction, the bracket including:
a cart support unit (for example, the cart support unit 10 shown in FIG. 1) configured to support the wheel support member using a support plate that is open on upper and front sides;
a door plate unit (for example, the door plate unit 20 shown in FIG. 1) configured to secure an outer periphery of the wheel support member supported on the support plate; a rotation support unit (for example, the rotation support unit 30 shown in FIGS. 1 and 3) configured to support the door plate unit in a rotatable manner; and
a lock unit (for example, the lock unit 40 shown in FIG. 4) configured to restrict rotation of the door plate unit when the door plate unit is closed with respect to the support plate and permit the rotation of the door plate unit when the restriction is released, wherein
the rotation of the door plate unit is restricted by the lock unit as a result of the door plate unit being closed with respect to the support plate after the vehicle transport cart has been loaded from the front side of the support plate and supported on the support plate, and
the vehicle transport cart is allowed to be taken out from the front side as a result of the door plate unit being opened with respect to the support plate after the restriction has been released and the rotation of the door plate unit has been permitted.

(2) In the bracket described above, the support plate includes a bottom plate part (for example, the bottom plate part 14 shown in FIG. 2) and a back plate part (for example, the back plate part 15 shown in FIG. 2) arranged perpendicular to each other in a cross-sectional view,
the door plate unit includes a front plate part (for example, the front plate part 21 shown in FIG. 2) and a top plate part (for example, the top plate part 22 shown in FIG. 2) arranged perpendicular to each other in a cross-sectional view, and the bottom plate part and the back plate part of the support plate, and the front plate part and the top plate part of the door plate unit are positioned so as to enclose the outer periphery of the wheel support member when the door plate unit is closed with respect to the support plate.

(3) In the bracket described above, the lock unit includes:
a rod-shaped member (for example, the engagement shaft 41 shown in FIG. 6) provided inside the door plate unit;
a hook-shaped part (for example, the lock lever 42 shown in FIG. 6) engageable with the rod-shaped member;
a secured shaft (for example, the secured shaft 43 shown in FIG. 6) provided in the cart support unit and supporting the hook-shaped part in a rotatable manner;
an operation lever (for example, the operation lever 45 shown in FIG. 6) rotatable in a direction for disengaging the hook-shaped part from the rod-shaped member; and
a biasing part (for example, the coil spring 46 shown in FIG. 7) configured to bias the hook-shaped part in a direction for engaging the hook-shaped part with the rod-shaped member around the secured shaft,
the hook-shaped part engages with the rod-shaped member to restrict the rotation of the door plate unit as a result of the door plate unit being closed with respect to the support plate, and
the hook-shaped part rotates in a direction for disengaging from the rod-shaped member against biasing force of the biasing part as a result of the operation lever being moved in the direction for disengaging the hook-shaped part from the rod-shaped member.

(4) The bracket described above further includes a key lock unit (for example, the key lock unit 50 shown in FIG. 3) switchable between a locked position for restricting the rotation of the door plate unit closed with respect to the support plate and an unlocked position for permitting the rotation of the door plate unit.

(5) In the bracket described above, an upper side of the back plate part of the support plate in a height direction has an inclined portion (for example, the inclined portion 15a shown in FIG. 2).

### EXPLANATION OF REFERENCE NUMERALS

1: Bracket
10: Cart support unit
11: Support plate
14: Bottom plate part
15: Back plate part
15a: Inclined portion
20: Door plate unit
21: Front plate part
22: Top plate part
30: Rotation support unit
40: Lock unit
41: Engagement shaft
42: Lock lever
43: Secured shaft
45: Operation lever
46: Coil spring
50: Key lock unit

What is claimed is:

1. A bracket for securing a vehicle transport cart having wheels respectively provided on opposite sides of a wheel support member in a longitudinal direction, the bracket comprising:
a cart support unit configured to support the wheel support member using a support plate that is open on upper and front sides;
a door plate unit configured to secure an outer periphery of the wheel support member supported on the support plate;
a rotation support unit configured to support the door plate unit in a rotatable manner; and
a lock unit configured to restrict rotation of the door plate unit when the door plate unit is closed with respect to the support plate and permit the rotation of the door plate unit when the restriction is released, wherein
the rotation of the door plate unit is restricted by the lock unit as a result of the door plate unit being closed with respect to the support plate after the vehicle transport cart has been loaded from the front side of the support plate and supported on the support plate, and
the vehicle transport cart is allowed to be taken out from the front side as a result of the door plate unit being opened with respect to the support plate after the restriction has been released and the rotation of the door plate unit has been permitted.

2. The bracket according to claim 1, wherein
the support plate includes a bottom plate part and a back plate part arranged perpendicular to each other in a cross-sectional view,
the door plate unit includes a front plate part and a top plate part arranged perpendicular to each other in a cross-sectional view, and
the bottom plate part and the back plate part of the support plate, and the front plate part and the top plate part of the door plate unit are positioned so as to enclose the outer periphery of the wheel support member when the door plate unit is closed with respect to the support plate.

3. The bracket according to claim 1, wherein
the lock unit includes:
a rod-shaped member provided inside the door plate unit;
a hook-shaped part engageable with the rod-shaped member;
a secured shaft provided in the cart support unit and supporting the hook-shaped part in a rotatable manner;
an operation lever rotatable in a direction for disengaging the hook-shaped part from the rod-shaped member; and
a biasing part configured to bias the hook-shaped part in a direction for engaging the hook-shaped part with the rod-shaped member around the secured shaft,
the hook-shaped part engages with the rod-shaped member to restrict the rotation of the door plate unit as a result of the door plate unit being closed with respect to the support plate, and
the hook-shaped part rotates in a direction for disengaging from the rod-shaped member against biasing force of the biasing part as a result of the operation lever being moved in the direction for disengaging the hook-shaped part from the rod-shaped member.

4. The bracket according to claim 3, further comprising
a key lock unit switchable between a locked position for restricting the rotation of the door plate unit closed with respect to the support plate and an unlocked position for permitting the rotation of the door plate unit.

5. The bracket according to claim 2, wherein
an upper side of the back plate part of the support plate in a height direction has an inclined portion.
